(19) United States
(12) Patent Application Publication
(10) Pub. No.: US 2025/0361759 A1
(43) Pub. Date: Nov. 27, 2025

(54) SLIDING DOOR ASSEMBLY

(71) Applicant: Alan Rees, Oceanside, CA (US)

(72) Inventor: Alan Rees, Oceanside, CA (US)

(21) Appl. No.: 18/671,709

(22) Filed: May 22, 2024

(51) Int. Cl. E05D 15/06; E05D 7/00; E05D 11/00; E05D 15/58; E06B 3/50

(52) U.S. Cl. CPC E05D 15/0604; E05D 7/0027; E05D 11/0081; E05D 15/581; E06B 3/5072; E05D 2015/485; E05D 2015/586; E05Y 2201/684; E05Y 2201/688; E05Y 2400/445; E05Y 2400/61

(57) ABSTRACT

A sliding door assembly. The sliding door assembly includes a door frame having an upper track and a lower track. A swing door is mounted to the door frame and multiple sliding doors are also mounted to the frame. The sliding doors slide when they are in a sliding configuration and also swing open and closed when they are in a swing configuration. Each sliding door includes an electronic door control switch, an upper track shoot bolt linear actuator for extending and retracting a shoot bolt, a upper track hinge pin linear actuator for extending and retracting a hinge pin, a lower track lift wheel linear actuator for extending and retracting a lift wheel assembly, a rigidly attached hinge wheel assembly having rotatably connected hinge wheels, and a power supply for providing power to the electronic door control switch, the shoot bolt linear actuator, the hinge pin linear actuator and the lift wheel linear actuator. When the upper track shoot bolt and the lower track lift wheel assembly are extended and the upper hinge pin is retracted, then the sliding door assembly is in a sliding configuration. When the upper track shoot bolt and lower track lift wheel assembly are retracted and the upper hinge pin is extended, then the sliding door assembly is a swing configuration.

The present invention relates to sliding door assemblies, and in particular, to sliding door assemblies having sliding doors and swing doors.

### BACKGROUND OF THE INVENTION

There are variety of sliding door assemblies disclosed in the prior art. For example, one such prior art device is disclosed in U.S. Pat. No. 9,194,172 “Sliding Door Structure Having Sliding Doors and Pivoting Doors”. The prior art sliding door assembly disclosed in the '172 patent shows sliding doors that are held adjacent to one another by the use of magnets. Unfortunately, the magnetic force utilized in the '172 patent may be difficult to overcome when attempting to slide the doors apart if the operator has a physical strength challenge (for example, when the operator is very young or very old). Also, the sliding door assembly disclosed in the '172 patent may, on occasion, swing open prematurely at an undesired location as the door is being slid to the correct position.

Additionally, other prior art designs are cumbersome, expensive and include parts that need frequent repair and maintenance.

What is needed is a better more efficient sliding door assembly that overcomes the faults with prior art door assemblies.

### SUMMARY OF THE INVENTION

The present invention provides a sliding door assembly. The sliding door assembly includes a door frame having an upper track and a lower track. A swing door is mounted to the door frame and multiple sliding doors are also mounted to the frame. The sliding doors slide when they are in a sliding configuration and also swing open and closed when they are in a swing configuration. Each sliding door includes an electronic door control switch, an upper track shoot bolt linear actuator for extending and retracting a shoot bolt, a upper track hinge pin linear actuator for extending and retracting a hinge pin, a lower track lift wheel linear actuator for extending and retracting a lift wheel assembly, a rigidly attached hinge wheel assembly having rotatably connected hinge wheels, and a power supply for providing power to the electronic door control switch, the shoot bolt linear actuator, the hinge pin linear actuator and the lift wheel linear actuator. When the upper track shoot bolt and the lower track lift wheel assembly are extended and the upper hinge pin is retracted, then the sliding door assembly is in a sliding configuration. When the upper track shoot bolt and lower track lift wheel assembly are retracted and the upper hinge pin is extended, then the sliding door assembly is a swing configuration.

### BRIEF DESCRIPTION OF THE DRAWINGS

FIGS. 1-7 show the operation of a preferred embodiment of the present invention.

FIGS. 8A-8E show details of a preferred sliding door.

FIG. 9 shows electrical components used in a preferred embodiment of the present invention.

FIG. 10 shows a preferred sliding door in a sliding configuration.

FIG. 11 shows a preferred sliding door in a swing configuration.

FIGS. 12-25 show further operational steps of a preferred embodiment of the present invention.

FIGS. 26A-28 show another preferred embodiment of the present invention.

### DETAILED DESCRIPTION OF THE PREFERRED EMBODIMENTS

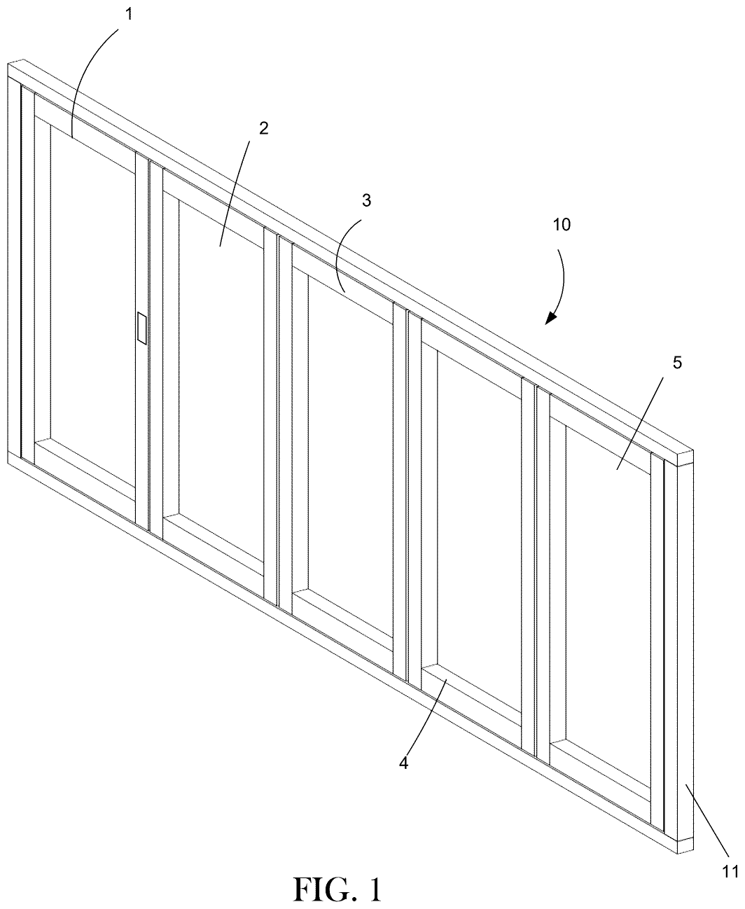

FIG. 1 shows a preferred embodiment of the present invention. Sliding door assembly 10 includes pivotally attached swing door 1 and sliding doors 2-5. Doors 1-5 are mounted into door frame 11. Door 1 is a swing door and is pivotally mounted to door frame 11 in the position shown. Doors 2-5 are sliding doors that are also capable of swinging open when in the appropriate position. In FIG. 1 doors 2-5 are sliding connected to frame 11 in the positions shown.

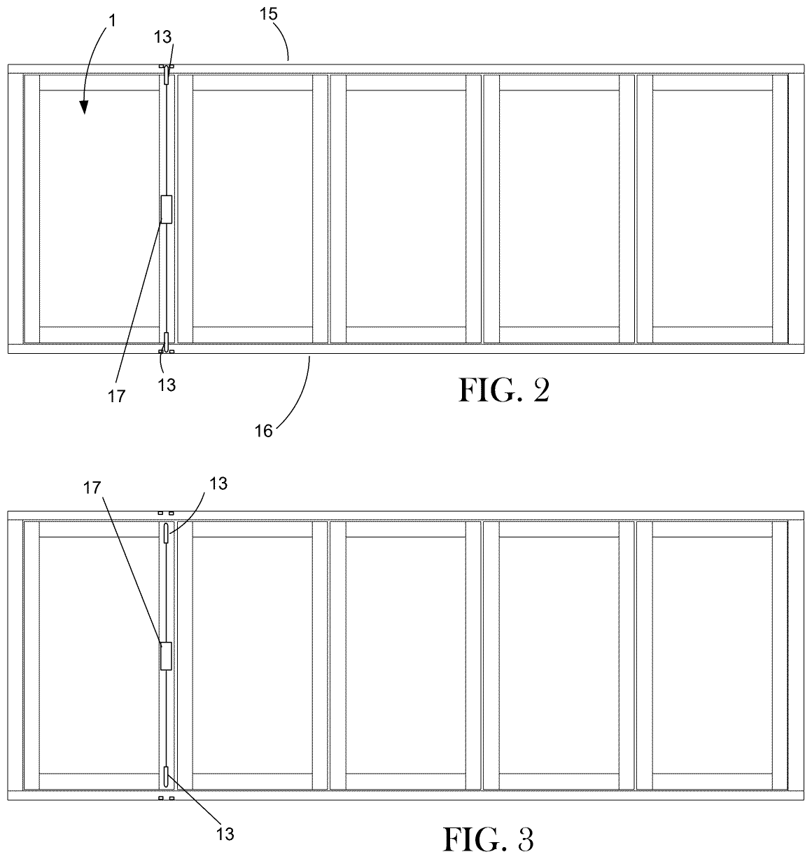

In FIG. 2, swing door 1 is locked with bolts 13 locked into upper track 15 and lower track 16 as shown.

In FIG. 3, an operator has utilized a key to unlock electric lock 17, thereby causing bolts 13 to retract from upper tracks 15 and 16 so that swing door 1 is now free to swing open.

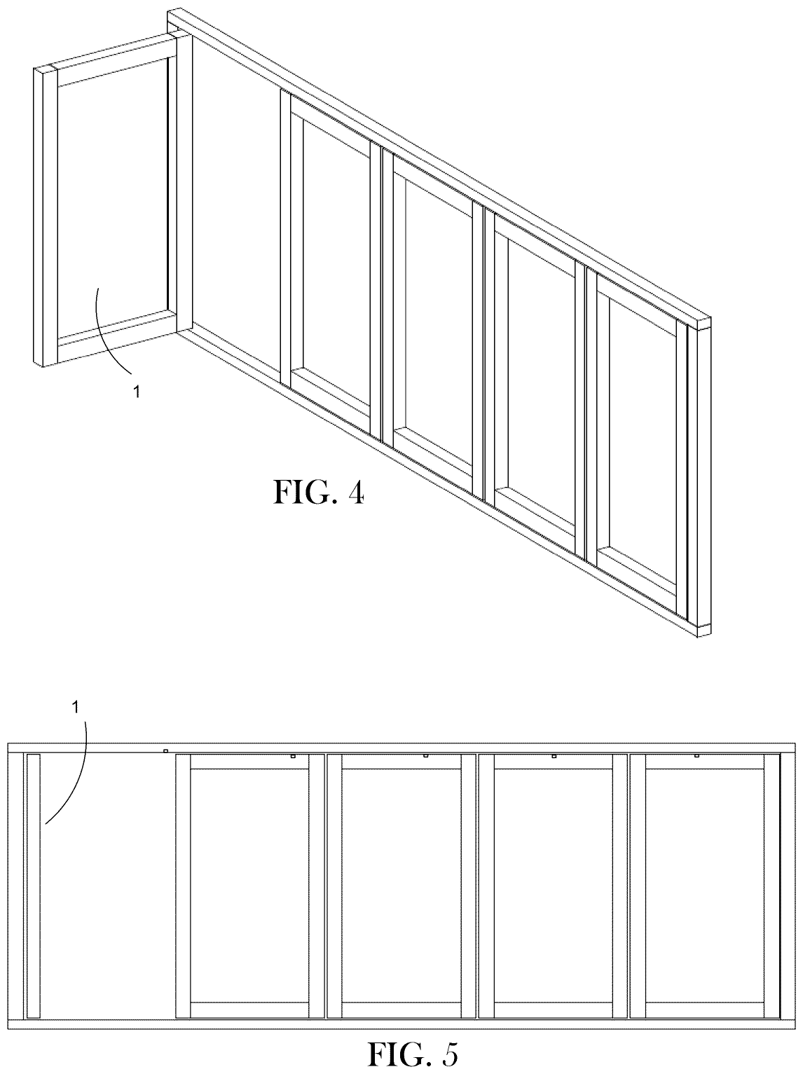

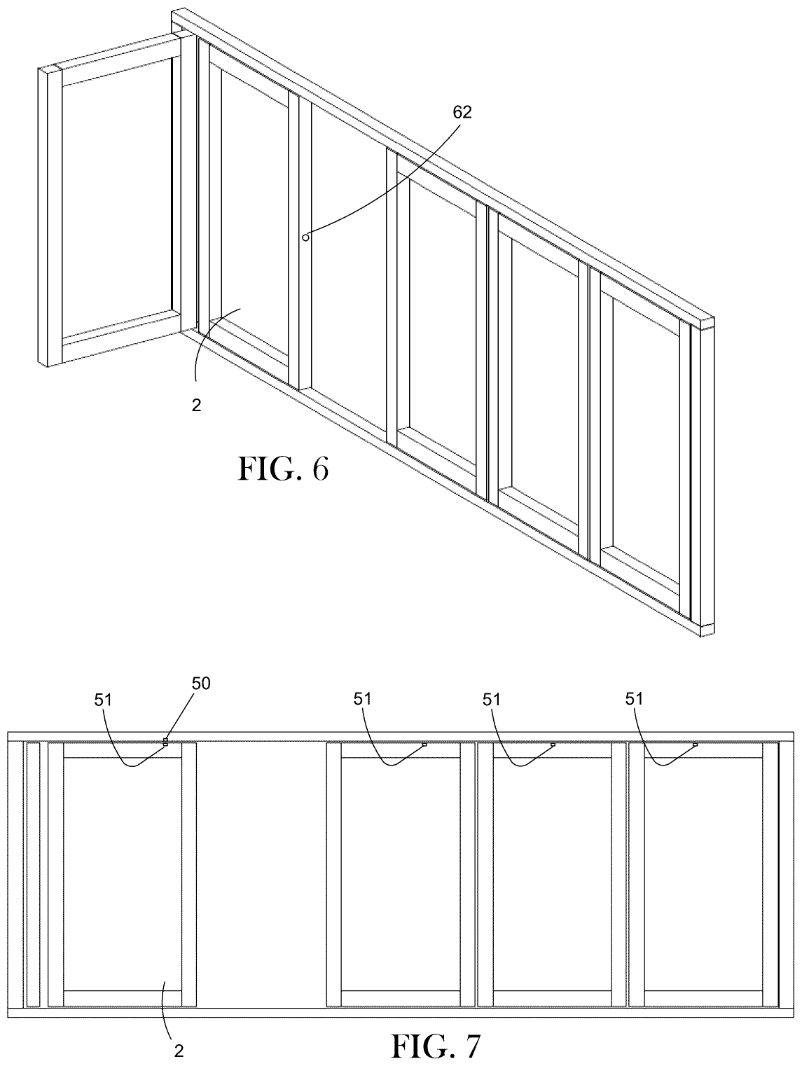

In FIGS. 4 and 5 the operator has swung open swing door 1.

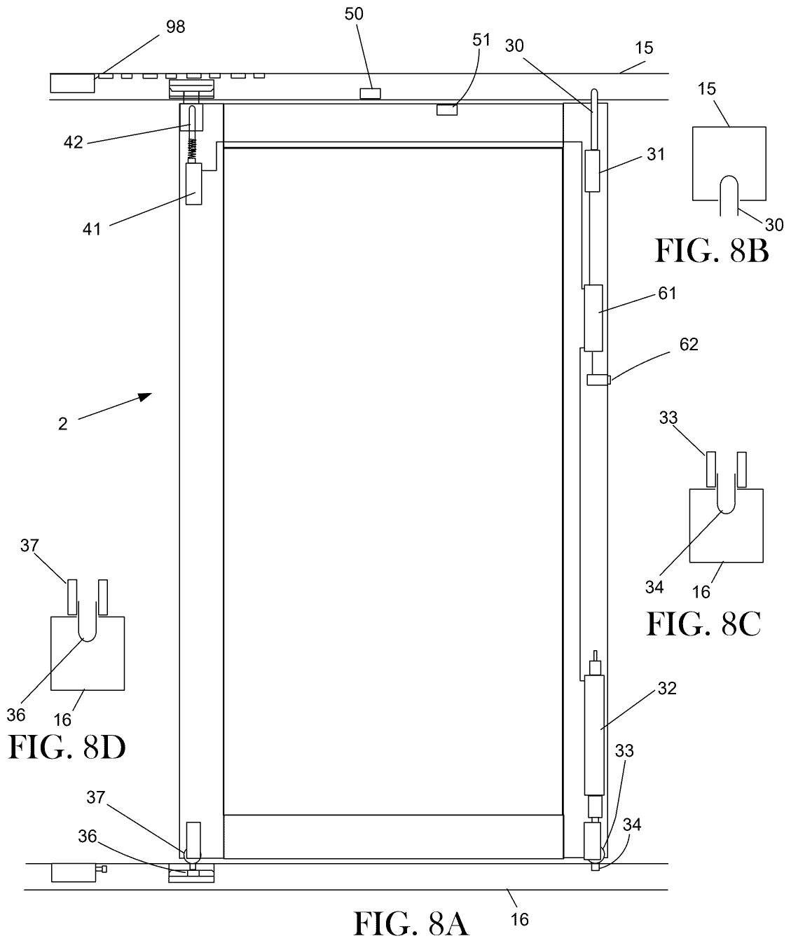

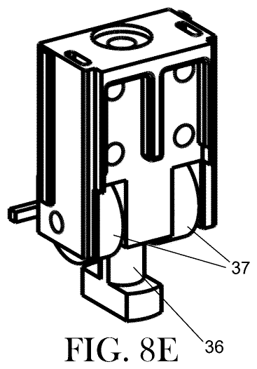

In FIGS. 6 and 7 the operator has slid sliding door 2 to the left as shown. In order to slide effectively sliding door 2 components are in the sliding configuration position shown in FIG. 8A.

For example, as shown in FIG. 8A, shoot bolt 30 (FIG. 8B) is inserted into a slot in upper track 15, to allow sliding door 2 to slide while also preventing its opening. Retractable lift wheels 33 (FIG. 8C) are running on the top of lower track 16 and extension bolt 34 is inserted into a slot in lower track 16, to allow sliding door 2 to slide while also preventing its opening. Hinge wheels 37 (FIG. 8D) are running on the top of lower track 16 and lower extension guide 36 is inserted into a slot in lower track 16 to permit the sliding of door 2 and to keep door 2 properly aligned. Upper hinge locking pin 42 is retracted to permit the sliding of door 2.

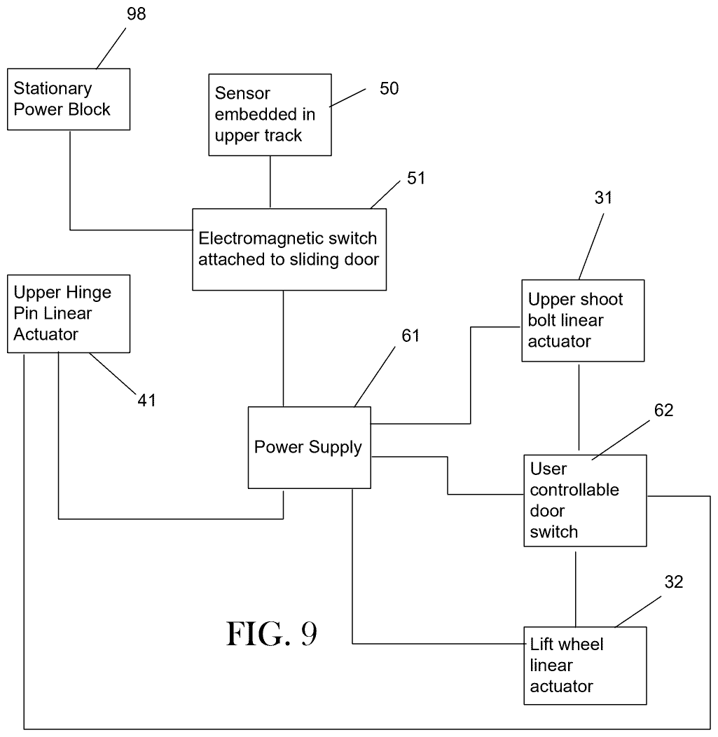

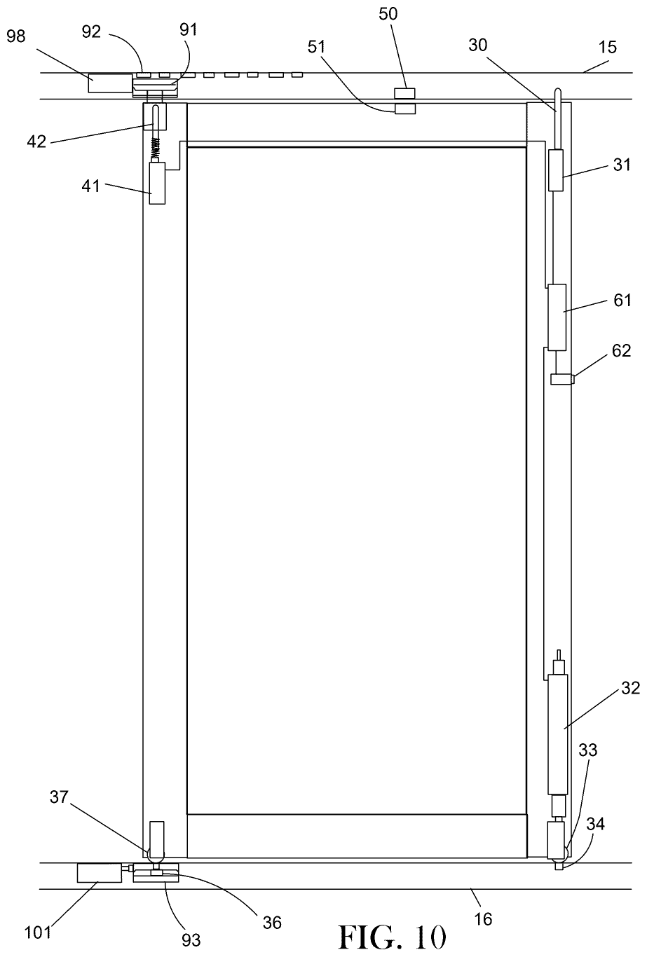

In FIG. 7, sliding door 2 is positioned so that door mounted electromagnetic switch 51 is positioned underneath sensor 50. Sensor 50 is embedded into upper track 15 as shown. When electromagnetic switch 51 is adjacent to sensor 50 (FIGS. 7, 9, 10), electromagnetic switch 51 closes the connection from stationary power block 98 thereby allowing electricity to flow to the following electrical components: user controllable door switch 62, upper shoot bolt linear actuator 31, upper hinge pin linear actuator 41, and lift wheel linear actuator 32. In a preferred embodiment, door switch 62 lights up when switch 51 is under sensor 50, indicating that the sliding door is in the appropriate position to swing open, as shown in FIG. 10.

In FIG. 10, sliding door 2 is in the position shown in FIGS. 6 and 7 and is in the appropriate position to swing open. Upper hinge pin 42 is positioned under pin receptor 92. Moveable hinge block 91 is rigidly connected to the door as shown. Hinge block 91 is electrically conductive and is in contact with power block 98, allowing electricity to flow from power block 98 through hinge block 91 to the door electrical components. Lower hinge block 93 is in contact with lower stationary block 101.

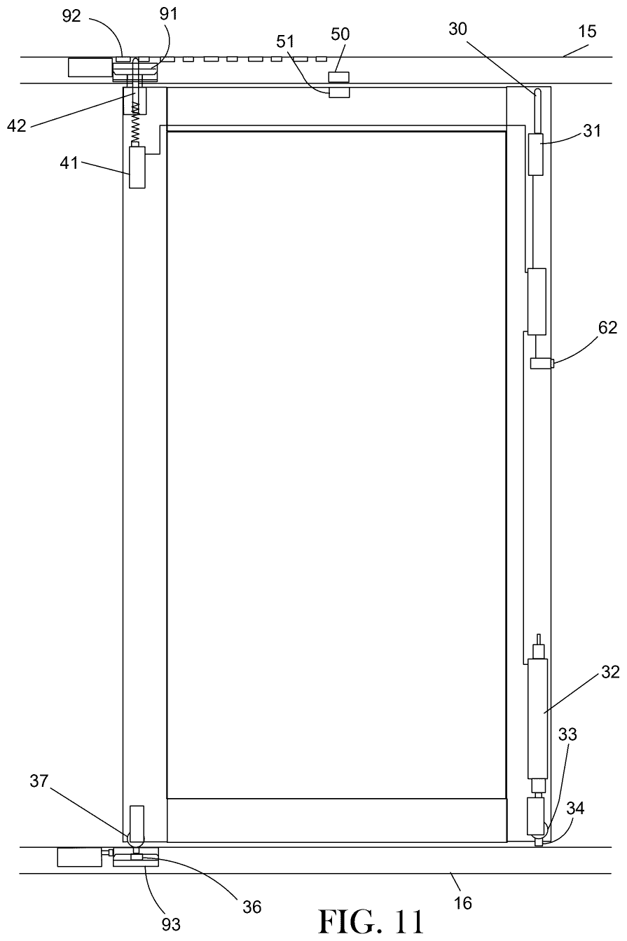

In FIG. 11, the operator has pressed door switch 62. This has caused: 1) linear actuator 31 to retract shoot bolt 30 so that it has cleared upper track 15 which will allow door 2 to swing open, 2) linear actuator 32 to retract wheels 33 and extension bolt 34 so that it is clear of lower track 16 which will allow door 2 to swing open, and 3) linear actuator 41 to move hinge locking pin 42 upward through upper track hinge 91 and engage pin receptor 92 to prevent further horizontal motion from door 2 and to lock door 2 into a swing position.

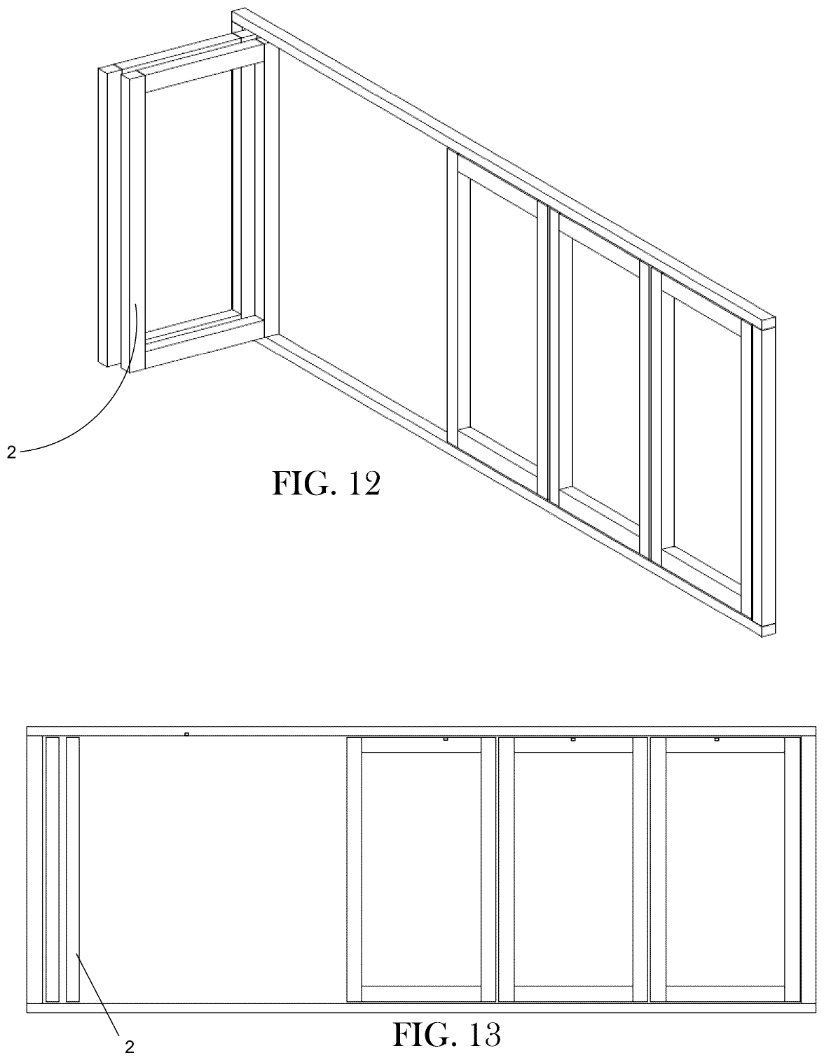

In FIGS. 12 and 13 the operator has swung open door 2.

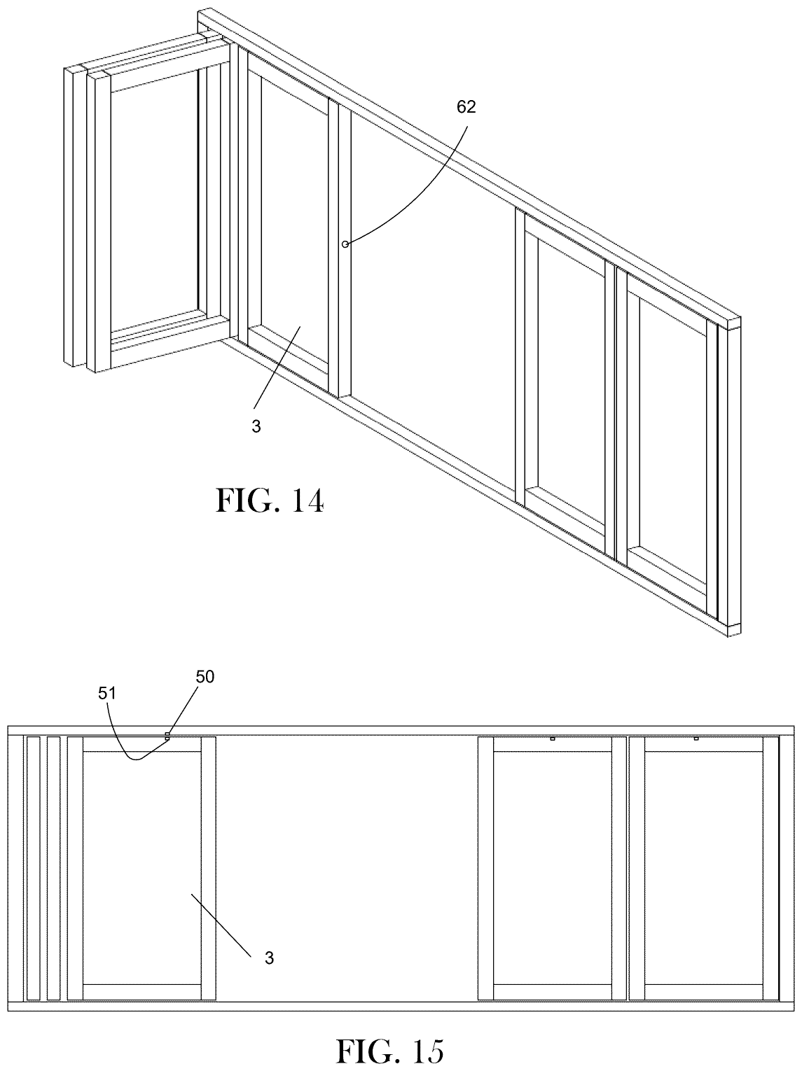

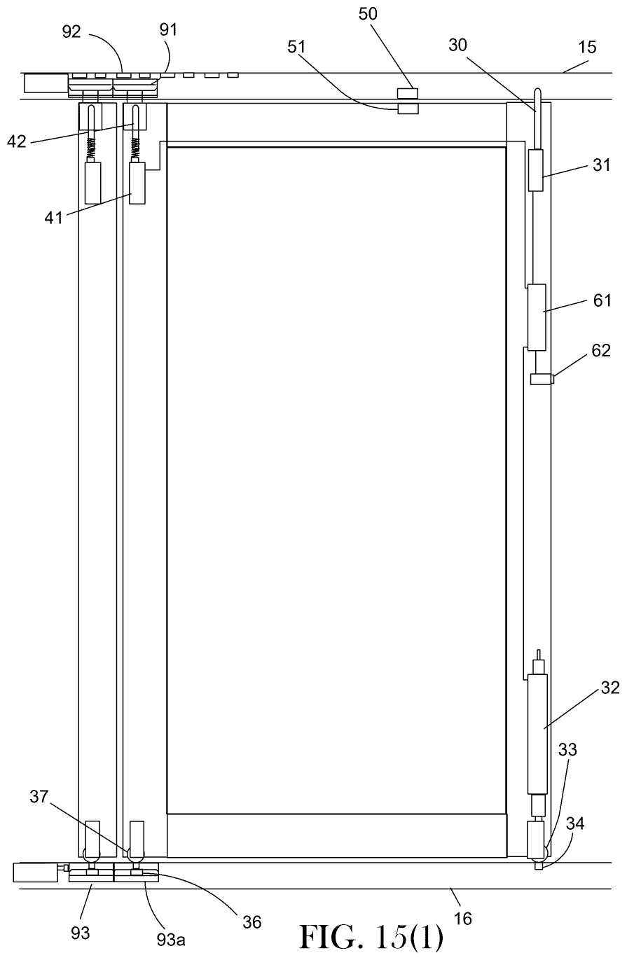

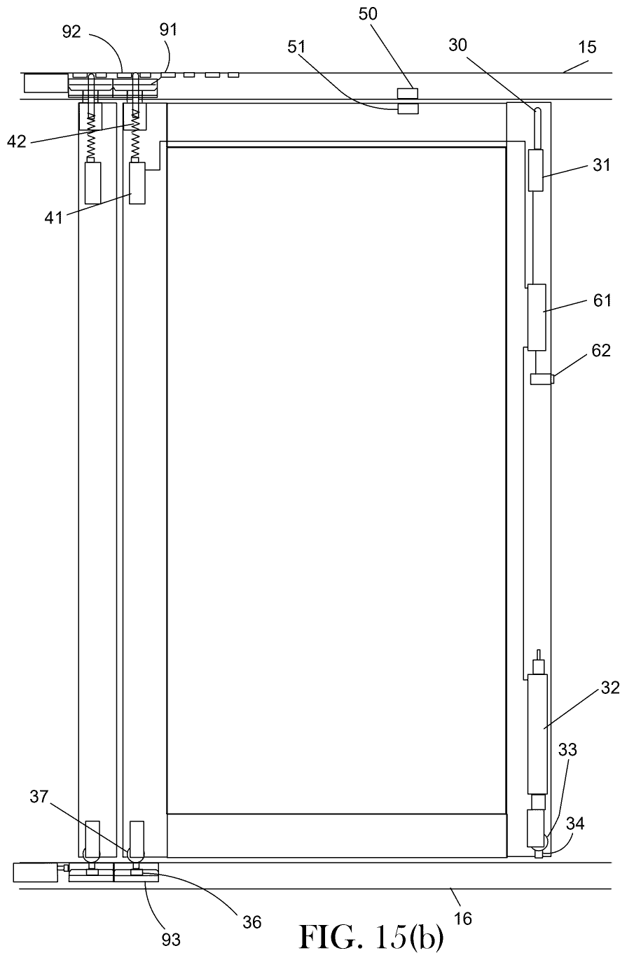

In FIGS. 14 and 15 the operator has slid door 3 to the left so that electromagnetic switch 51 is positioned underneath sensor 50. Door switch 62 has lit up, indicating that sliding door 3 is in the appropriate position to swing open, as shown in FIG. 10.

In FIG. 15(1), sliding door 3 is in the position shown in FIGS. 14 and 15 and is in the appropriate position to swing open. Upper hinge pin 42 is positioned under pin receptor 92. Moveable hinge block 91b is rigidly connected to the door as shown. Hinge block 91b is in contact with hinge block 91. Electricity can flow from power block 98 through hinge blocks 91 and 91b Lower hinge block 93a is in contact with lower hinge block 93.

In FIG. 15(2), the operator has pressed door switch 62. This has caused: 1) linear actuator 31 to retract shoot bolt 30 so that it has cleared upper track 15 which will allow door 3 to swing open, 2) linear actuator 32 to retract wheels 33 and extension bolt 34 so that it is clear of lower track 16 which will allow door 3 to swing open, and 3) linear actuator 41 to move hinge locking pin 42 upward through upper track hinge 91 and engage pin receptor 92 to prevent further horizontal motion from door 3 and to lock door 3 into a swing position.

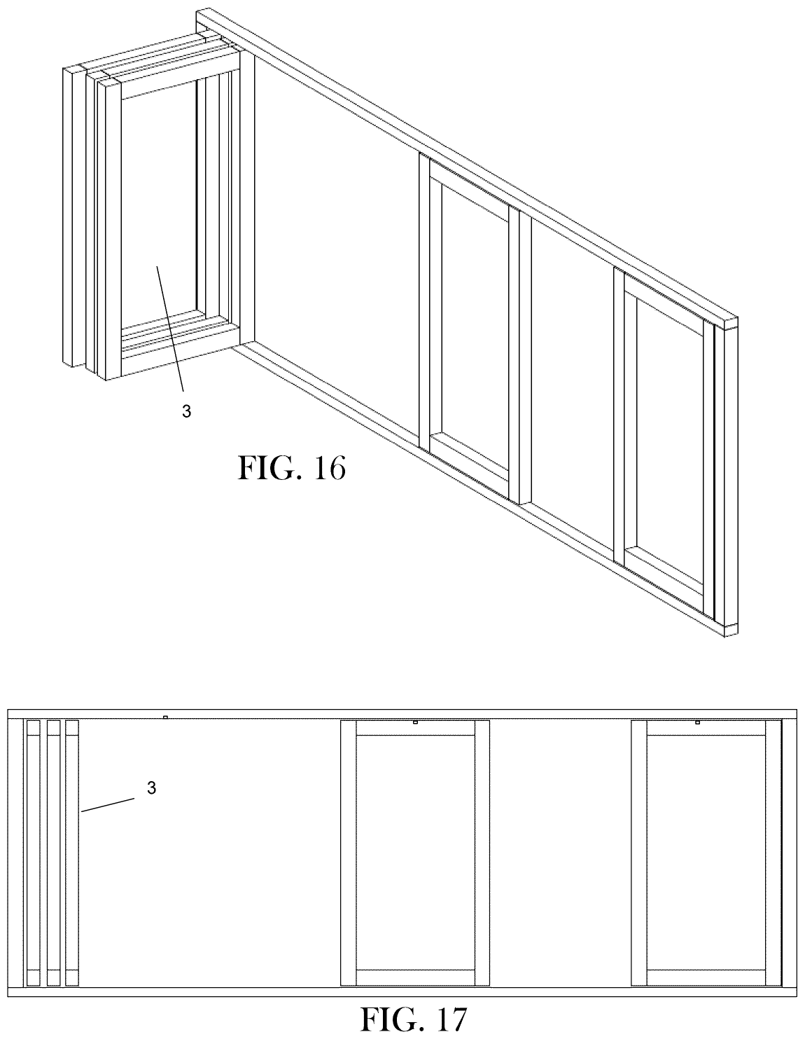

In FIGS. 16 and 17 the operator has swung open door 3.

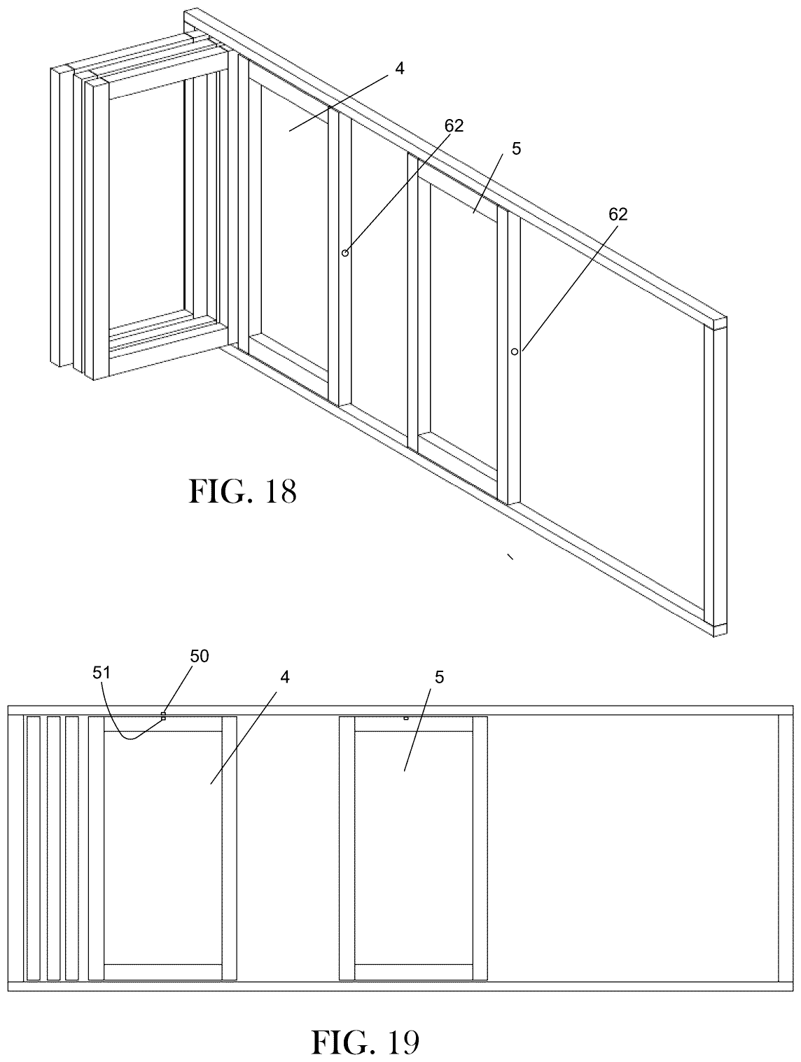

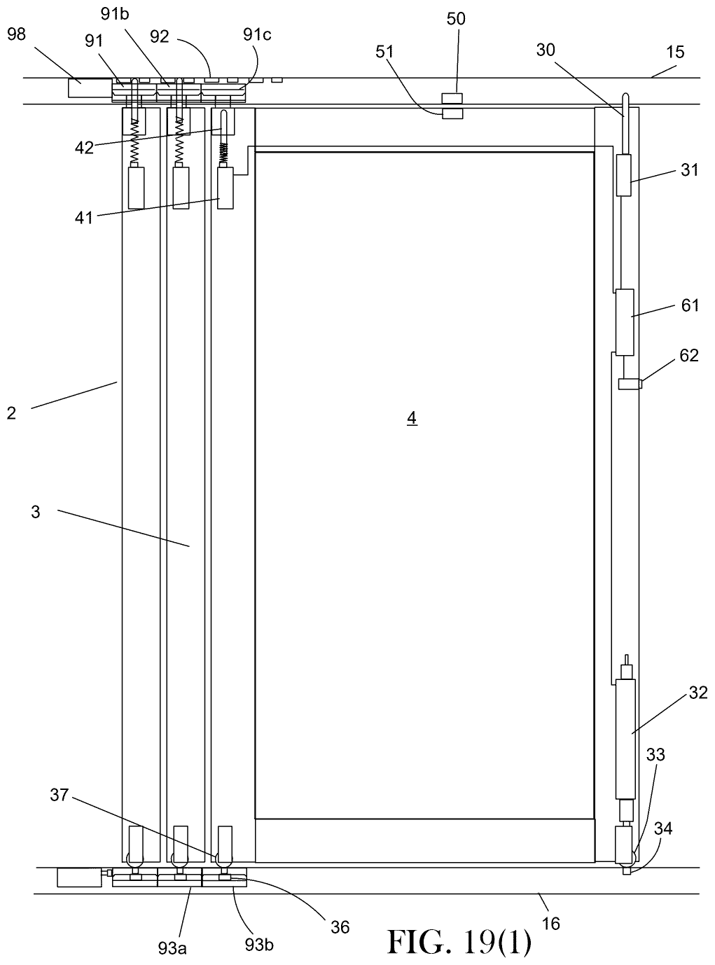

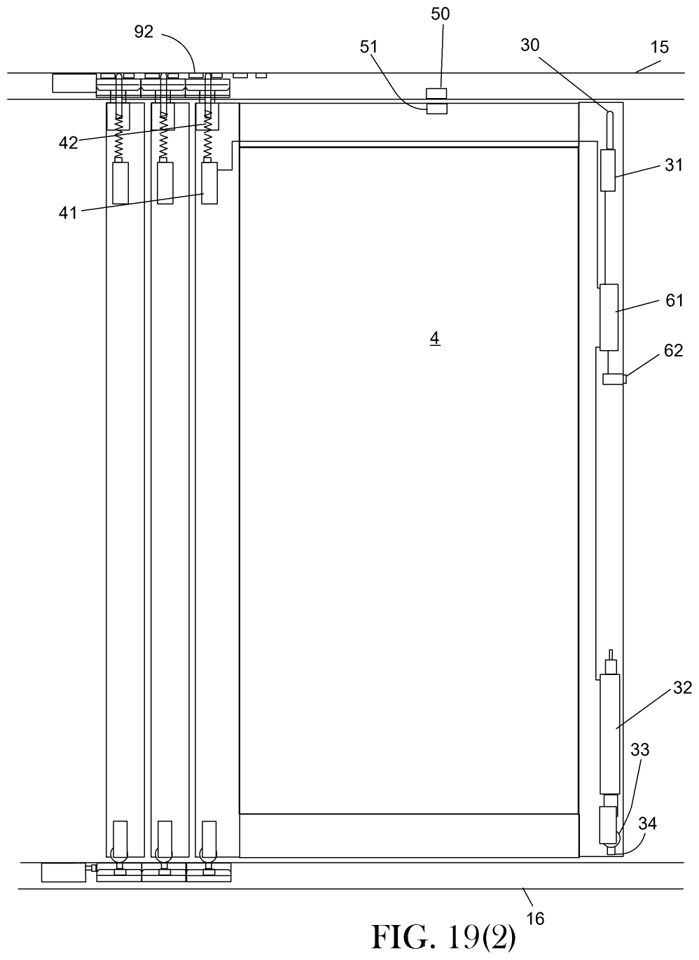

In FIGS. 18 and 19 the operator has slid door 4 to the left so that electromagnetic switch 51 is positioned underneath sensor 50. Door switch 62 has lit up, indicating that sliding door 4 is in the appropriate position to swing open, as shown in FIG. 19(1). The operator has also slid door 5 slightly to the left.

In FIG. 19(1), sliding door 4 is in the position shown in FIGS. 18 and 19 and is in the appropriate position to swing open. Upper hinge pin 42 is positioned under pin receptor 92. Moveable hinge block 91c is rigidly connected to the door as shown. Hinge block 91c is in contact with hinge block 91b. Electricity can flow from power block 98 through hinge blocks 91, 91b and 91c. Lower hinge block 93b is in contact with lower hinge block 93a.

In FIG. 19(2), the operator has pressed door switch 62. This has caused: 1) linear actuator 31 to retract shoot bolt 30 so that it has cleared upper track 15 which will allow door 4 to swing open, 2) linear actuator 32 to retract wheels 33 and extension bolt 34 so that it is clear of lower track 16 which will allow door 4 to swing open, and 3) linear actuator 41 to move hinge locking pin 42 upward through upper track hinge 91 and engage pin receptor 92 to prevent further horizontal motion from door 4 and to lock door 2 into a swing position.

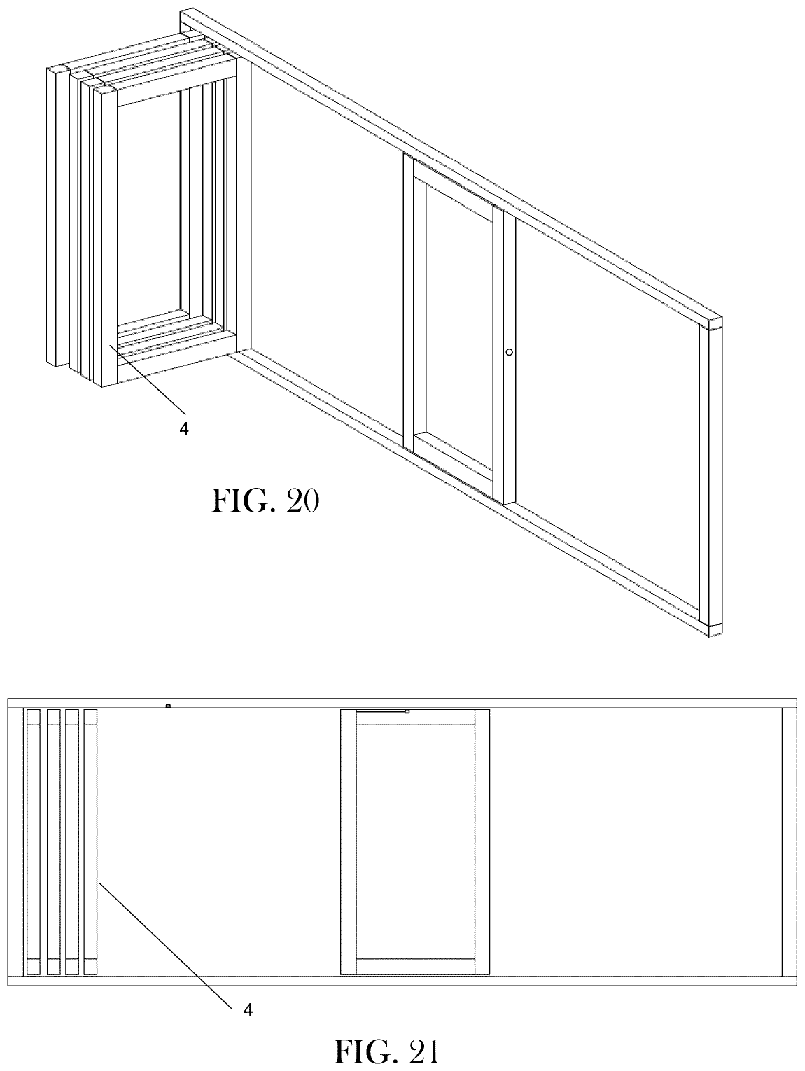

In FIGS. 20 and 21 the operator has swung open door 4.

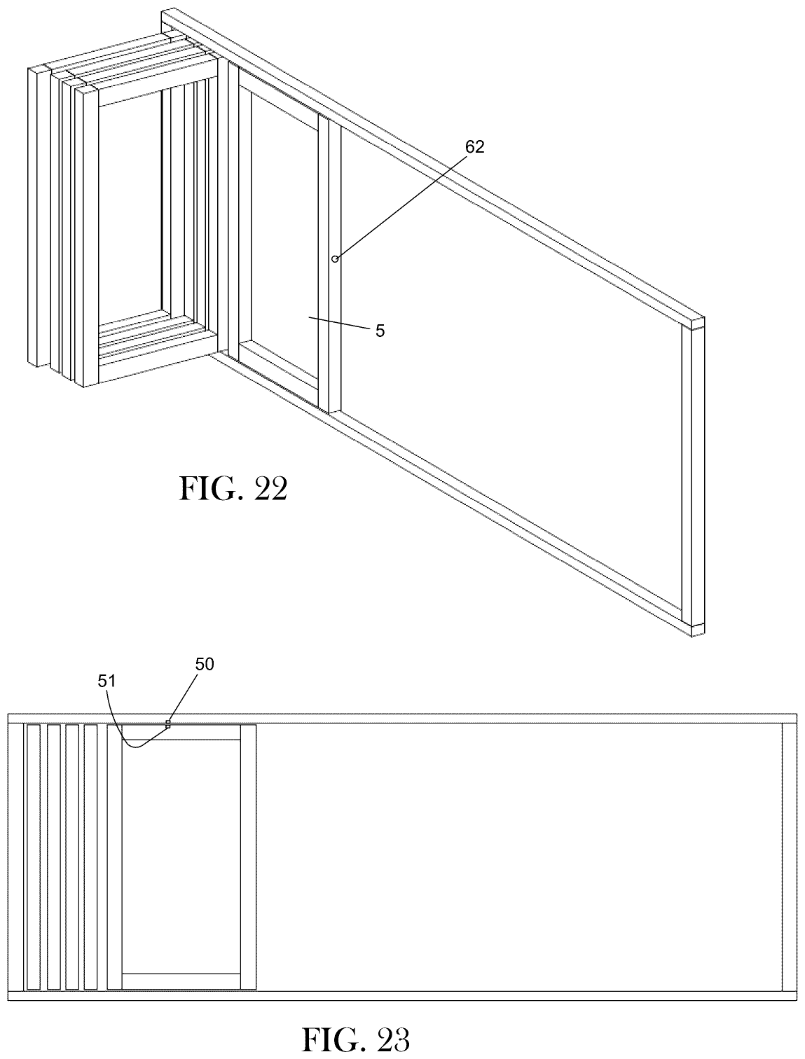

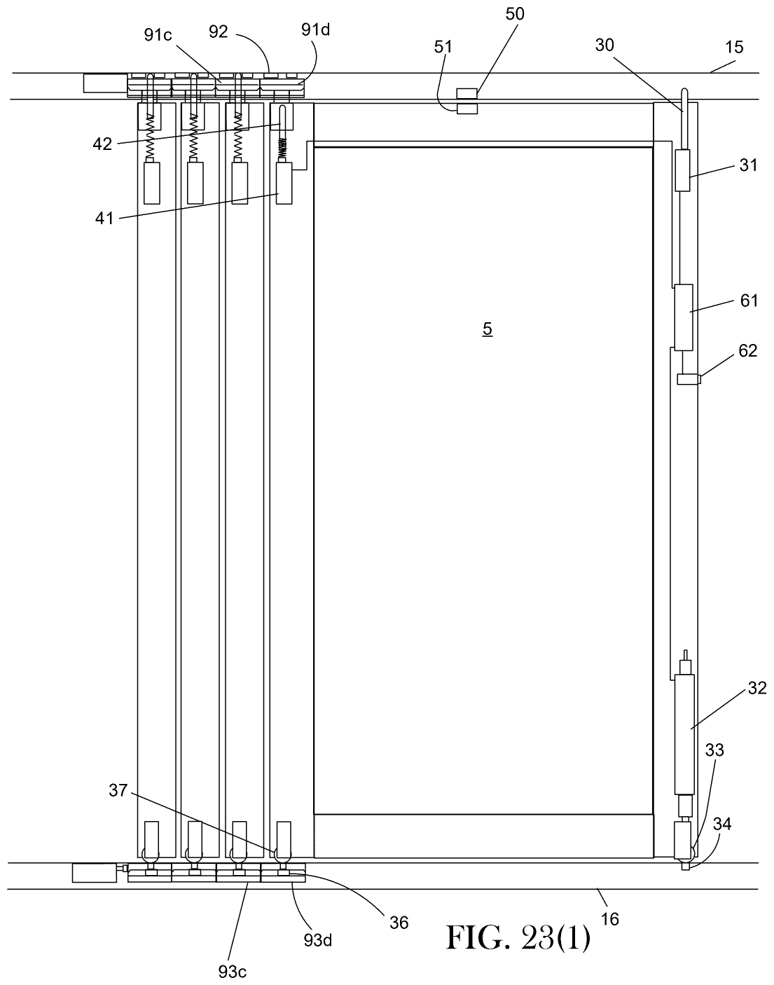

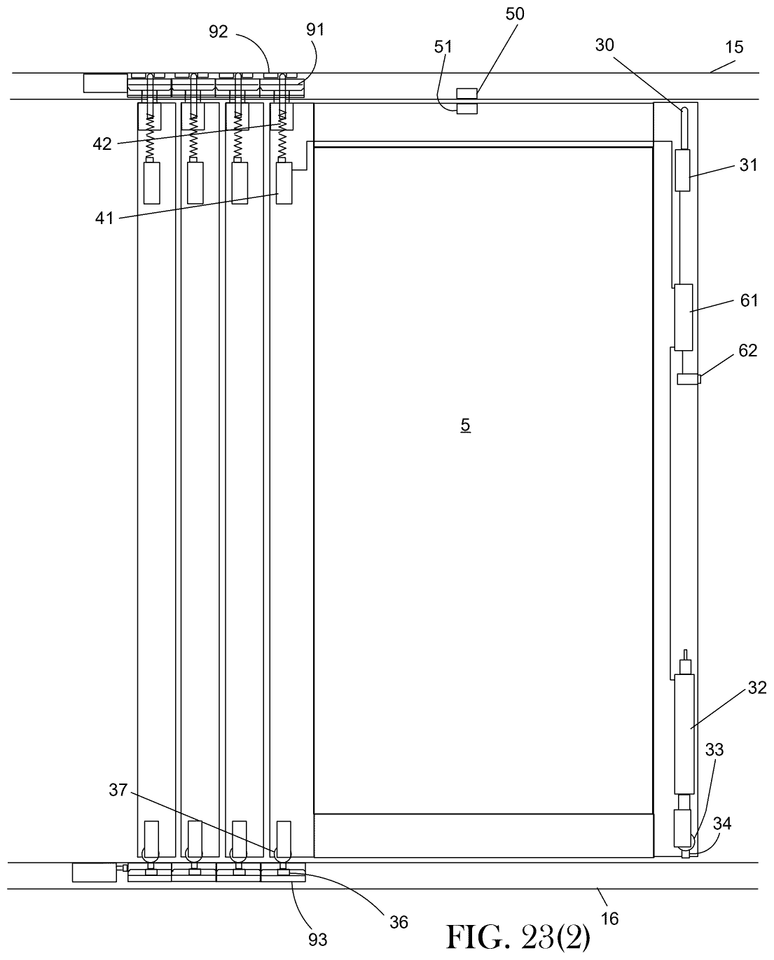

In FIGS. 22 and 23 the operator has slid door 5 to the left so that electromagnetic switch 51 is positioned underneath sensor 50. Door switch 62 has lit up, indicating that sliding door 5 is in the appropriate position to swing open, as shown in FIG. 23(1).

In FIG. 23(1), sliding door 5 is in the position shown in FIGS. 22 and 23 and is in the appropriate position to swing open. Upper hinge pin 42 is positioned under pin receptor 92. Moveable hinge block 91d is rigidly connected to the door as shown. Hinge block 91d is in contact with hinge block 91c. Electricity can flow from power block 98 through hinge blocks 91, 91b, 91c and 91d. Lower hinge block 93d is in contact with lower hinge block 93c.

In FIG. 23(2), the operator has pressed door switch 62. This has caused: 1) linear actuator 31 to retract shoot bolt 30 so that it has cleared upper track 15 which will allow door 5 to swing open, 2) linear actuator 32 to retract wheels 33 and extension bolt 34 so that it is clear of lower track 16 which will allow door 5 to swing open, and 3) linear actuator 41 to move hinge locking pin 42 upward through upper track hinge 91 and engage pin receptor 92 to prevent further horizontal motion from door 5 and to lock door 5 into a swing position.

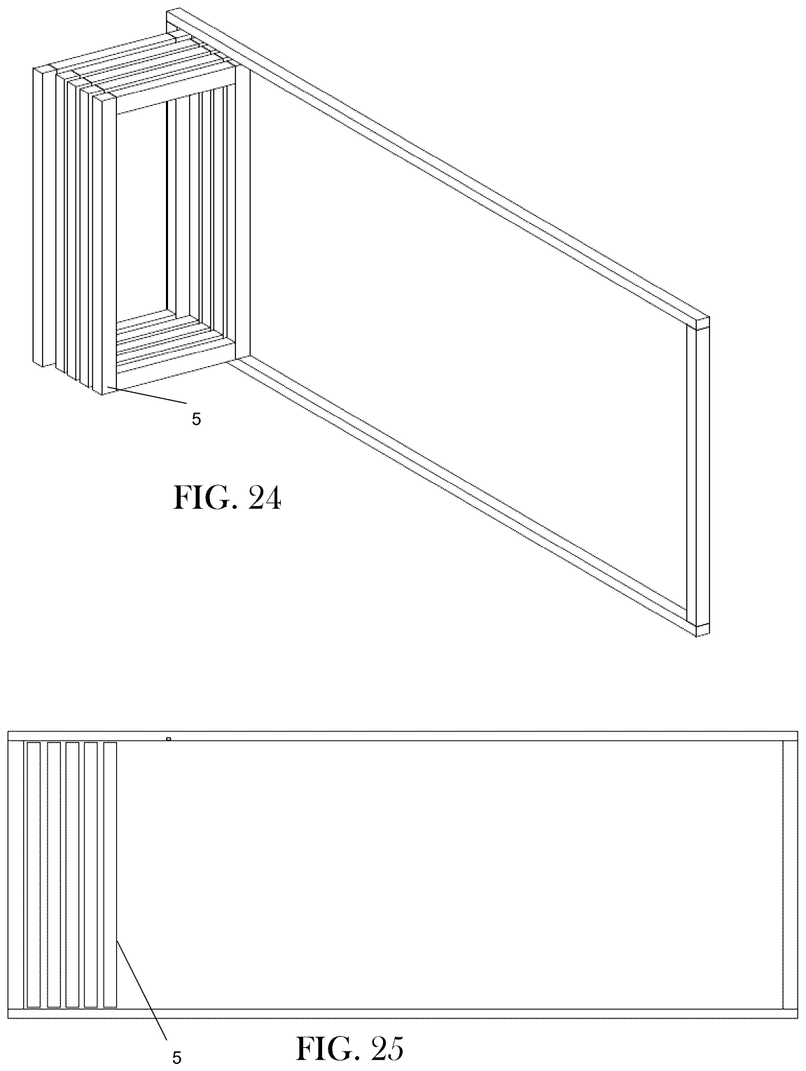

In FIGS. 24 and 25 the operator has swung open door 5.

To put door assembly 10 back in the position shown in FIG. 1, the operator merely executes the above-described steps in reverse. For example, in FIGS. 24 and 25, the operator can swing door 5 shut so that it is in the position shown in FIGS. 22 and 23, with sensor 50 positioned over electromagnetic switch 51. The operator will then press door switch 62. This will cause: 1) linear actuator 31 to extend shoot bolt 30 so that it is inserted into upper track 15 (FIG. 10), 2) linear actuator 32 to extend wheels 33 and extension bolt 34 so that wheels 33 are positioned on top of lower track 16 and extension bolt 34 is inserted into the slot of lower track 16, and 3) linear actuator 41 to retract hinge locking pin 42 downward so that it is clear of upper track 15. Door 5 will now be in a sliding configuration. Similar steps are to be repeated for doors 2-4 so that the doors may be slid to the positions shown in FIG. 1. Swing door 1 may then be swung shut and locked.

### Other Preferred Embodiment

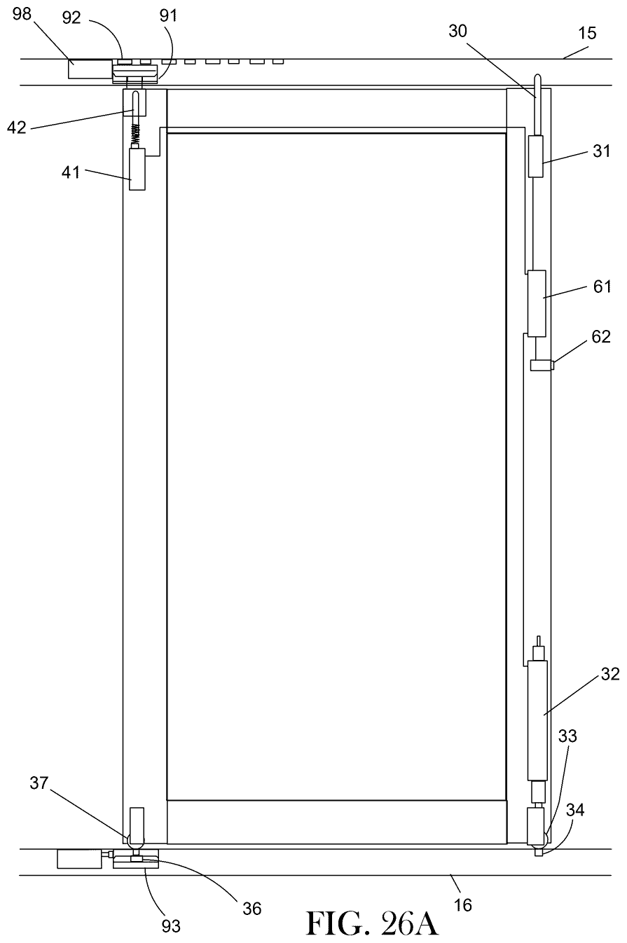

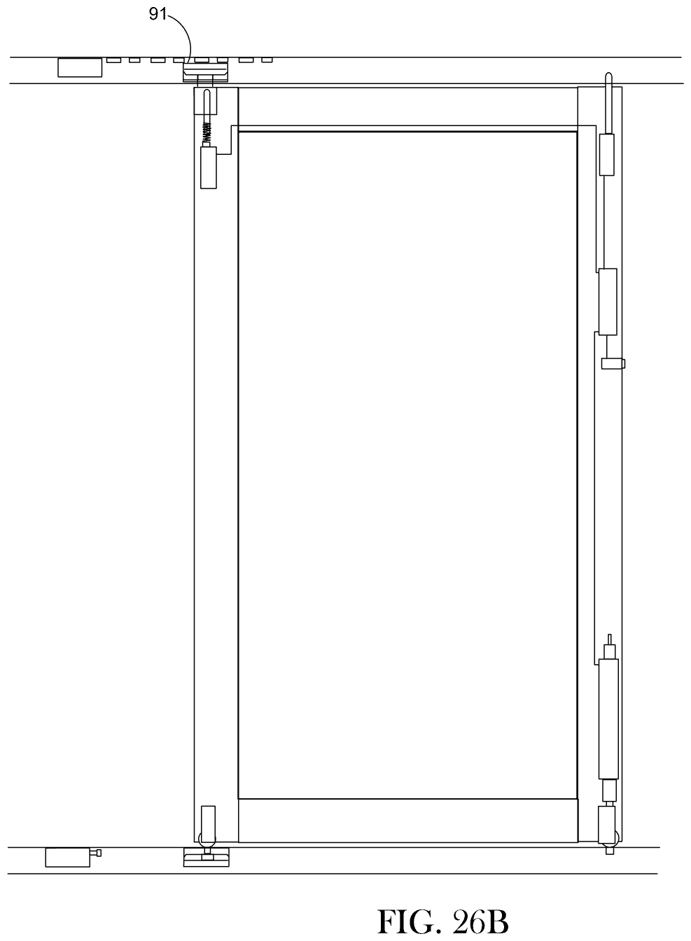

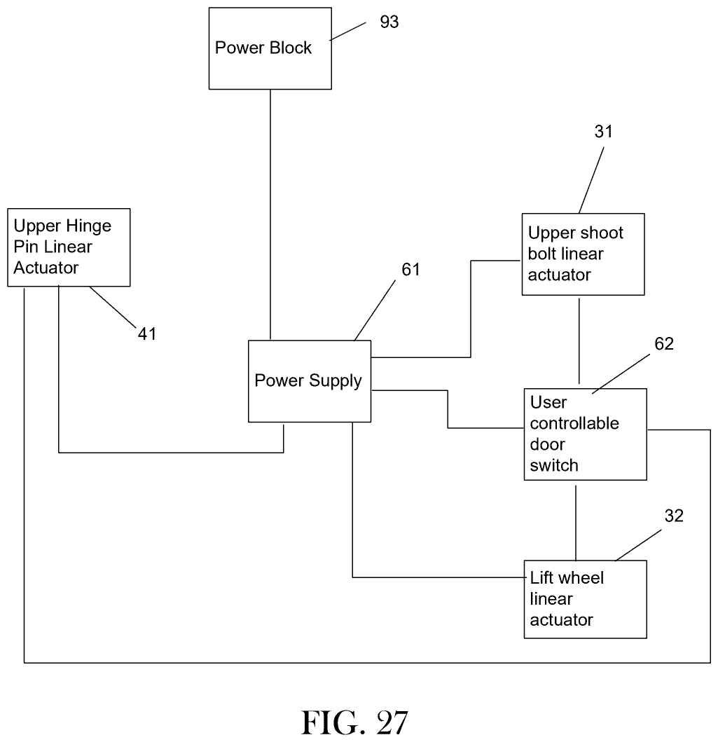

FIGS. 26A, 26B and 27 show another preferred embodiment of the present invention. In FIGS. 26A, 26B and 27, sensor 50 and electromagnetic switch 51 are no longer utilized. Instead, electrical power is transferred directly from stationary power block 98 to hinge block 91 and then to door electrical components. The completed circuit allows electricity to flow from power block 98 to power supply 61 to electronic door control switch 62, shoot bolt linear actuator 31, hinge pin linear actuator 41 and said lift wheel linear actuator 32. Conversely, when the electronic circuit is broken (i.e., the sliding door is not in the swing position (FIG. 26B)), power from power supply 61 is not permitted to flow to electronic door control switch 62, shoot bolt linear actuator 31, hinge pin linear actuator 41 and said lift wheel linear actuator 32.

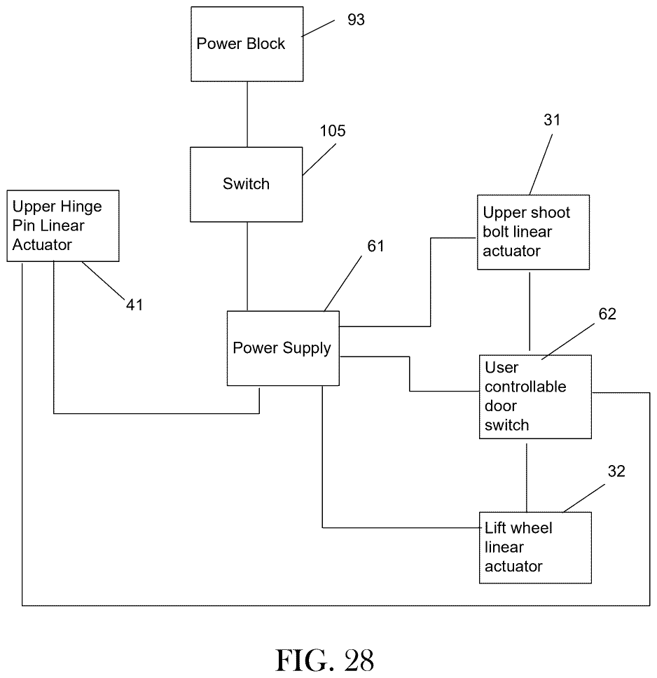

In the preferred embodiment shown in FIG. 28, electronic switch 105 is included. Electronic switch 105 is preferably mounted in hinge block 91 and functions to break the electrical connection from power block 98 to the door electrical components once the door is swung open. Conversely, electronic switch 105 will reestablish the electrical connection from power block 98 to the door electrical components once the door is swung closed.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

1. A sliding door assembly, comprising:
A) a door frame comprising:
i. a door frame upper track, and
ii. a door frame lower track,
B) at least one swing door pivotally mounted to said door frame,
C) at least one sliding door slidingly mounted to said door frame upper track and said door frame lower track, wherein said at least one sliding door may be placed in both a sliding configuration and a swing configuration, said at least one sliding door comprising:
i. an electronic door control switch,
ii. an upper track shoot bolt linear actuator in electronic communication with said electronic door control switch,
iii. an upper track hinge pin linear actuator in electronic communication with said electronic door control switch, and
iv. a lower track lift wheel linear actuator in electronic communication with said electronic door control switch,
v. an upper track shoot bolt extended and retracted by said upper track shoot bolt linear actuator,
vi. an upper track hinge pin extended and retracted by said upper track hinge pin linear actuator,
vii. a lower track lift wheel assembly extended and retracted by said lower track lift wheel linear actuator,
viii. a hinge wheel assembly rigidly mounted to said sliding door assembly and comprising rotatably connected hinge wheels, and
ix. a power supply for providing power to said electronic door control switch, said shoot bolt linear actuator, said hinge pin linear actuator and said lift wheel linear actuator,
wherein said upper track shoot bolt and said lower track lift wheel assembly are extended and said upper track hinge pin is retracted to place said at least one sliding door into said sliding configuration and wherein said upper track shoot bolt and said lower track lift wheel assembly are retracted and said upper track hinge pin is extended to place said at least one sliding door into said swing configuration.

2. The sliding door assembly as in claim 1, wherein said at least one sliding door is a plurality of sliding doors.

3. The sliding door assembly as in claim 1, wherein said upper track comprises a sensor embedded into said upper track and wherein said at least one sliding door comprises an electronic switch so that when said electronic switch is adjacent to said sensor, power from said power supply is permitted to flow to said electronic door control switch, said shoot bolt linear actuator, said hinge pin linear actuator and said lift wheel linear actuator, and when said electronic switch is not adjacent to said sensor, power from said power supply is not permitted to flow to said electronic door control switch, said shoot bolt linear actuator, said hinge pin linear actuator and said lift wheel linear actuator.

4. The sliding door assembly as in claim 1, wherein a circuit completion mechanism is embedded into either the upper track or lower track, wherein when said sliding door is in said swing configuration said circuit completion device completes an electronic circuit allowing power to flow to said electronic door control switch, said shoot bolt linear actuator, said hinge pin linear actuator and said lift wheel linear actuator, and when said sliding door is not in said swing configuration, power from said power supply is not permitted to flow to said electronic door control switch, said shoot bolt linear actuator, said hinge pin linear actuator and said lift wheel linear actuator.

5. The sliding door assembly as in claim 4, wherein said circuit completion mechanism is an electrically conductive movable hinge block attached to said at least one sliding door in contact with a power block attached to said door frame.

6. The sliding door assembly as in claim 1, wherein said door frame upper track comprises a swing configuration sensor, and wherein each sliding door comprises a swing configuration switch, wherein said swing configuration sensor is located at a fixed position on said upper track and wherein the position of each swing configuration switch attached to each sliding door is staggered relative to each other so as to ensure said swing configuration switch is always located underneath said swing configuration sensor when said door is in said swing configuration to permit swinging of said door.
